(19) United States
(12) Patent Application Publication
(10) Pub. No.: US 2025/0242562 A1
(43) Pub. Date: Jul. 31, 2025

(54) FINISHING PROFILE MEMBER FOR A PANEL

(71) Applicant: Safran Seats, Plaisir (FR)

(72) Inventors: Jeremy Cailleteau, Moissy-Cramayel (FR); Olivier Lefevre, Moissy-Cramayel (FR)

(21) Appl. No.: 18/853,053

(22) PCT Filed: Apr. 5, 2023
(86) PCT No.: PCT/EP2023/058930

§ 371 Date: Sep. 30, 2024

(30) Foreign Application Priority Data
Apr. 7, 2022 (FR) FR2203172

(51) Int. Cl. B32B 3/04; B32B 3/06; B32B 5/18; B32B 7/12; B64D 11/06

(52) U.S. Cl. CPC B32B 3/04; B32B 3/06; B32B 5/18; B32B 7/12; B32B 2305/022; B32B 2305/024; B64D 11/0602

(57) ABSTRACT

Disclosed is a finishing profile member intended to cover an edge surface of a panel, comprising:
a reinforcement comprising a web, a first flank and a second flank, a first fold extending between a first longitudinal edge of the web and the first flank, a second fold extending between a second longitudinal edge of the web and the second flank; and
an extendable textile cover that at least partially covers said reinforcement,
said reinforcement comprising a least one shaping zone in which a plurality of cuts are made, such that said reinforcement can be shaped along the shaping zone to follow a curvature profile of the edge surface of the panel.

The present invention relates to a finishing profile member for a panel. The invention finds a particularly advantageous, but not exclusive, application with composite panels forming furniture elements, in particular privacy shells or consoles belonging to seat units of “business class and “first class” type for an aircraft cabin.

In a manner known per se, a seat unit comprises a seat associated with a console and a privacy shell. The privacy shell extends at least partly around the seat so as to delimit a private semi-enclosed space around the passenger. Such a configuration makes it possible to guarantee the privacy of the passenger on the seat.

The seat offers the passenger different comfort positions, from a “sitting” position to a “lying” position, in which the seat defines a substantially horizontal sleeping surface for the passenger to lie down. Intermediate comfort positions are also provided, such as the “relaxed” position in which a seat back is strongly inclined. Generally, these intermediate positions are obtained by tilting the seat back pivoting about a horizontal axis perpendicular to an extension axis of the seat.

The console and/or privacy shell are formed by composite panels so-called of “sandwich” type, that is to say that these panels are made up of a stack of layers of different structural or non-structural materials. To finish the edge surfaces of these composite panels, it is necessary to cover them with a finishing profile member called “edgecap” member.

The finishing profile members can be made of metal, polymer or elastomer, machined or injected. However, this type of profile member requires to cut the profile member into several pieces (so-called “split line” technology) because the technological limits as well as the cost limits of the existing manufacturing methods do not allow the precise shapes of a finishing profile member extending in one piece along the entire length of the edge surface to be covered. In addition, this type of machined or injected profile member is not very tolerant in terms of dimensioning while the composite panels on which they are mounted have fairly large tolerances. This generates docking and perceived quality problems.

Finishing profile members can also consist of extruded profile members made of silicone elastomer or thermoplastic polyurethane (TPU). However, this type of profile member poses problems of perceived quality, as they have extrusion marks and are sensitive to scratches. This type of profile member also poses problems of bonding to the panel to be finished due to the very nature of the material.

The objective of the invention is to effectively remedy the aforementioned drawbacks by proposing a finishing profile member for covering an edge surface of a panel comprising:
a reinforcement comprising a wall, a first flank and a second flank, a first fold extending between a first longitudinal edge of the wall and the first flank, a second fold extending between a second longitudinal edge of the wall and the second flank, and
a extendable textile cover at least partially covering said reinforcement,
said reinforcement comprising at least one shaping zone in which a plurality of cuts are made, such that said reinforcement can be shaped along the shaping zone to follow a curvature profile of the edge surface of the panel.

The invention thus allows the finishing profile member to easily conform to complex panel curvatures. The invention is also a simple to manufacture and quick to install solution for obtaining a privacy shell panel or a console panel with an excellent quality finish. The invention also has the advantage of being inexpensive and lightweight, which limits the weight of the assembly.

According to one embodiment of the invention, the shaping zone comprises at least one cut in the reinforcement chosen from:
a first type of cut allowing the reinforcement to be shaped in the plane of the flanks following a convex shaping, so that a center of curvature of the reinforcement is located on the side of an internal face of the wall,
a second type of cut allowing the reinforcement to be shaped in the plane of the wall, so that a center of curvature of the reinforcement is located on the side of one of the flanks, and
a third type of cut allowing the reinforcement to be shaped in the plane of the flans following a concave shaping, so that a center of curvature of the reinforcement is located on the side of an external face of the wall, the third type of cut also allowing a twisting shaping process.

According to one embodiment of the invention, at least one cut extends transversely in the wall, and extends on one side in the first fold and along a portion of a width of the first flank, and on the other side in the second fold and along a portion of a width of the second flank.

According to one embodiment of the invention, at least one cut extends in one of the flanks, the corresponding fold connecting said flank to the wall, as well as in the wall up to the next fold.

According to one embodiment of the invention, a cut ends at least at one of its ends with a portion of rounded or oblong shape.

According to one embodiment of the invention, at least one cut comprises:
a first cut portion extending along the entire width of the first flank and slightly beyond the first fold, and
a second cut portion extending along the entire width of the second flank and slightly beyond the second fold,
the first cut portion and the second cut portion being located in the same plane perpendicular to a longitudinal extension direction of the finishing profile member.

According to one embodiment of the invention, said finishing profile member comprises several shaping zones having cuts of different shapes so as to be able to follow a panel edge surface profile having e directions in different successive directions.

According to one embodiment of the invention, the shaping zone comprises an alternation of two different types of cuts to adapt to simultaneous variations in curvature.

According to one embodiment of the invention, the reinforcement is free of cut when the edge surface profile of the panel is straight.

According to one embodiment of the invention, the textile cover comprises at least one finishing layer.

According to one embodiment of the invention, the textile cover can be finished in a straight cut at the edge of the reinforcement or beaded on itself from inside.

According to one embodiment of the invention, the textile cover further comprises an underlayer between the reinforcement and the finishing layer to hide the cuts.

According to one embodiment of the invention, the textile cover comprises a lateral bead along which said textile cover is folded over an internal face of the flanks.

According to one embodiment of the invention, said finishing profile member comprises a male butting shape on the side of a first end and a female butting shape on the side of a second end, said female butting shape having a shape complementary to the male butting shape.

According to one embodiment of the invention, the finishing profile member is glued to the edge surface of the panel at the internal face of the wall by means of a liquid, solid, and/or double-sided adhesive.

The invention will be better understood and other characteristics and advantages will appear by reading the following detailed description, which includes embodiments given for illustrative purposes with reference to the accompanying figures, presented as way of non-limiting examples, which may serve to complete the understanding of the present invention and the description of its implementation and eventually contribute to its definition, wherein:

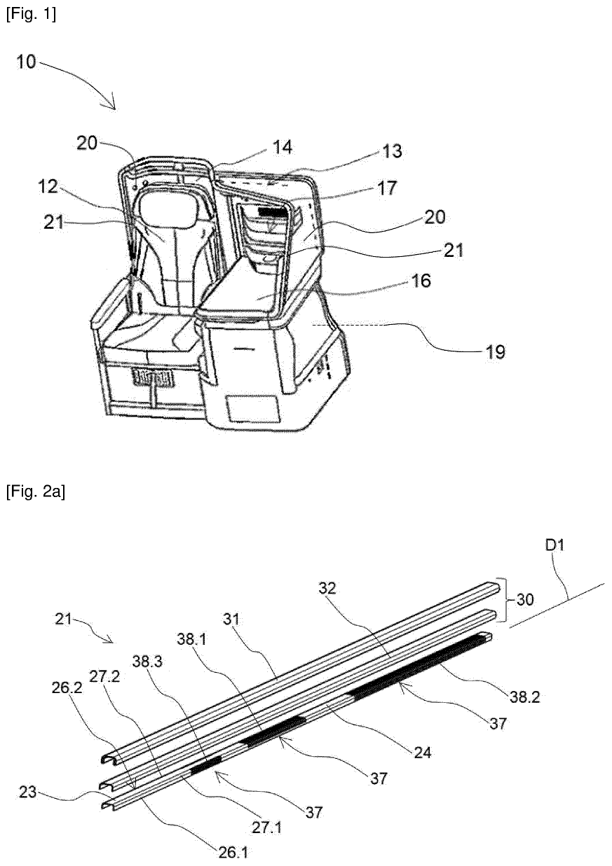

FIG. 1 is a perspective view of a seat unit according to the invention comprising a privacy shell and a console whose edge surfaces are covered by a finishing profile member according to the invention;

FIGS. 2a and 2b are respectively exploded perspective and cross-sectional views of a finishing profile member according to the invention in the unshaped state on the edge surface of a panel;

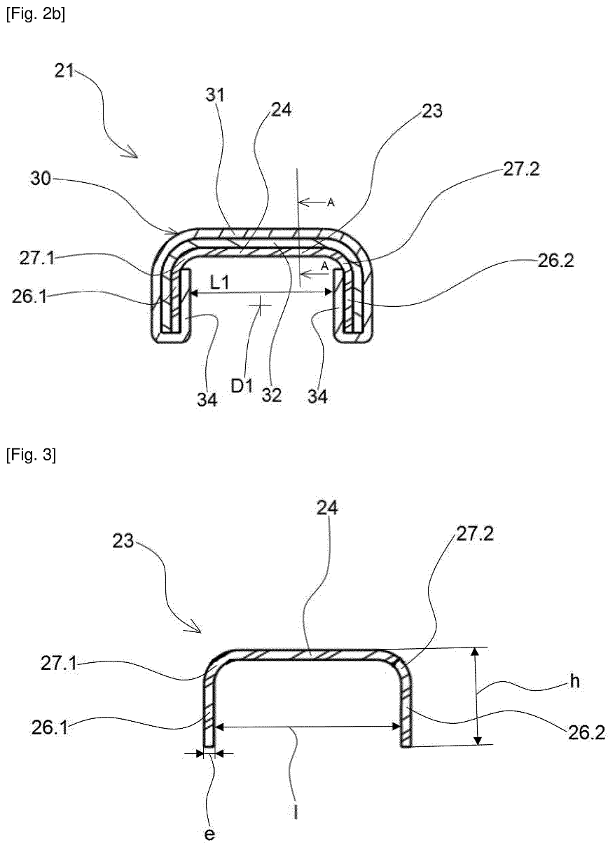

FIG. 3 is a cross-sectional view of a reinforcement belonging to the finishing profile member according to the invention;

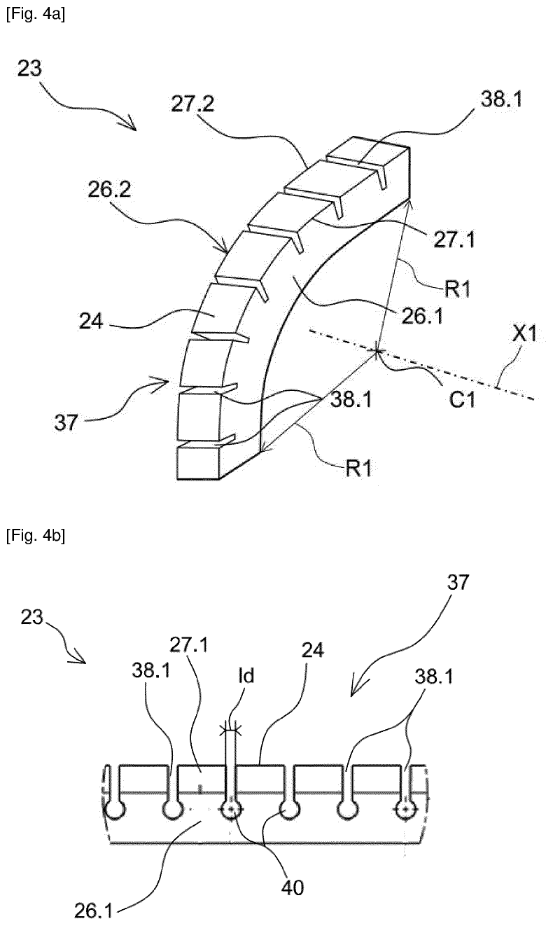

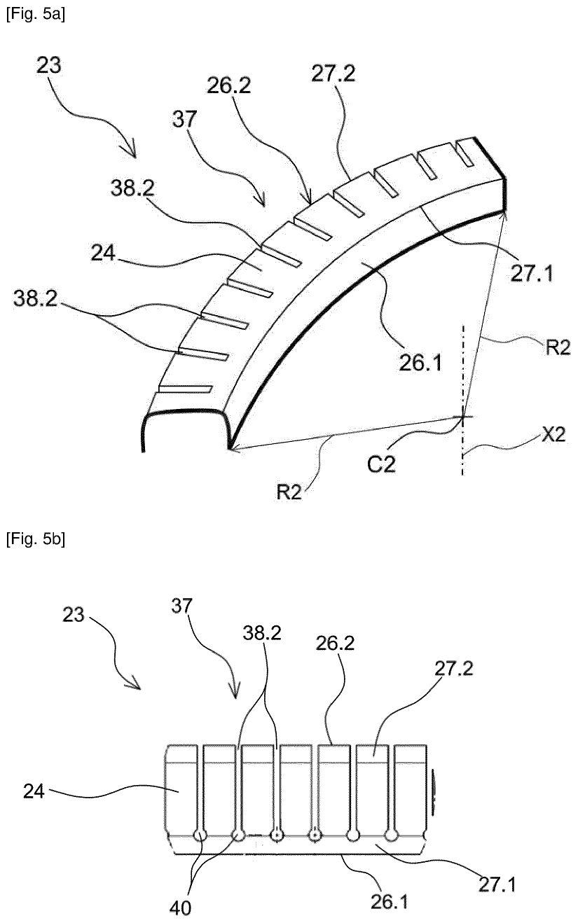

FIG. 4a is a perspective view of a finishing profile member according to the invention shaped with a first type of cut;

FIG. 4b is a partial side view of a finishing profile member according to the invention provided with the first type of cut;

FIG. 5a is a perspective view of a finishing profile member according to the invention shaped with a second type of cut;

FIG. 5b is a partial top view of a finishing profile member according to the invention provided with the second type of cut;

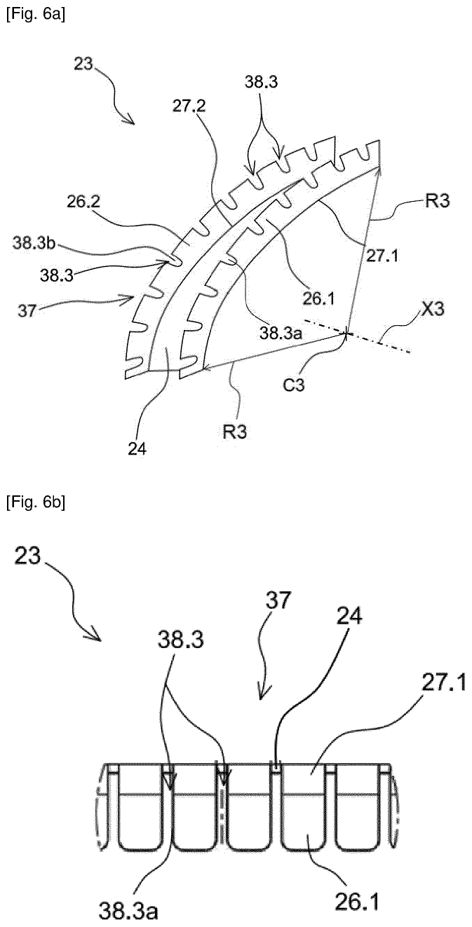

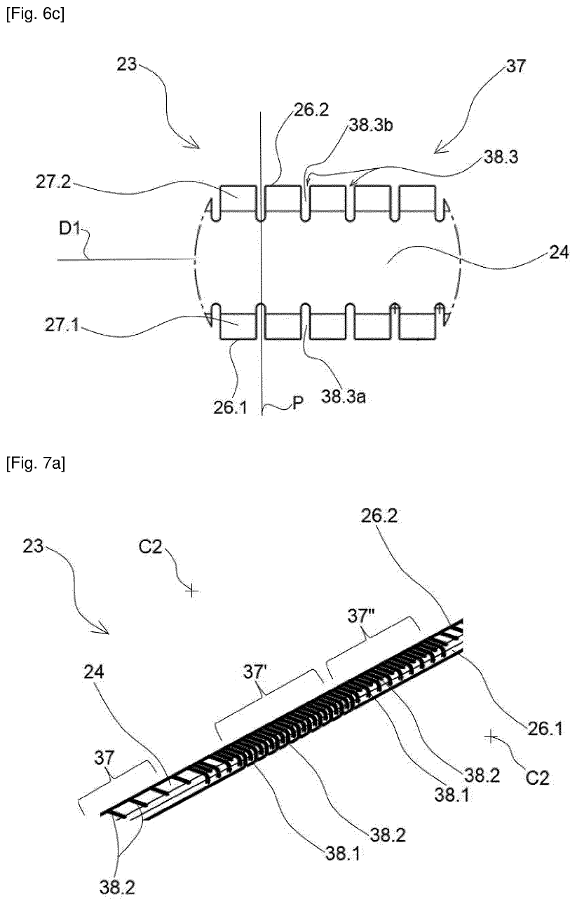

FIG. 6a is a perspective view of a finishing profile member according to the invention shaped with a third type of cut;

FIG. 6b is a partial side view of a finishing profile member according to the invention provided with the third type of cut;

FIG. 6c is a partial top view of a finishing profile member according to the invention provided with the third type of cut;

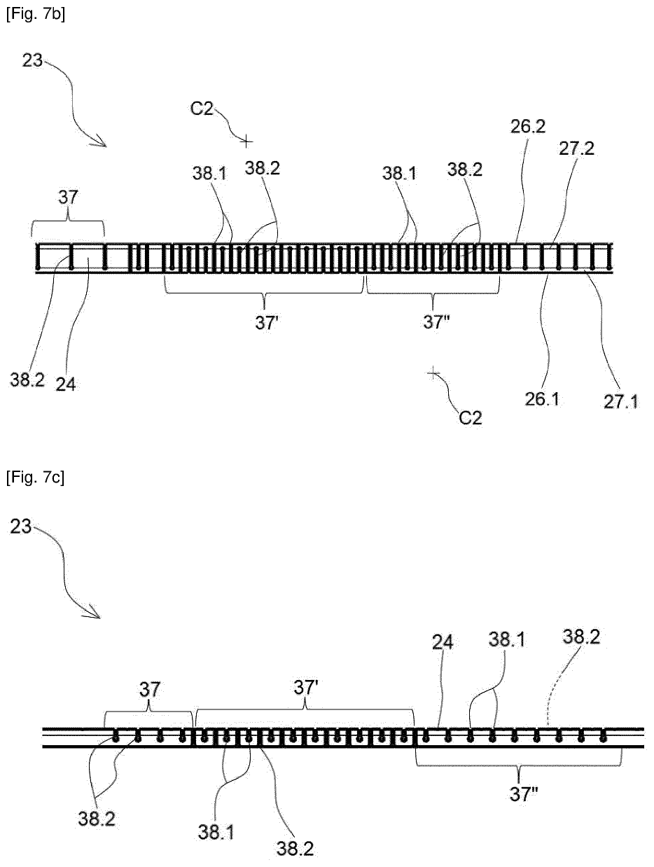

FIGS. 7a, 7b, and 7c are respectively perspective, top, and side views of a finishing profile member according to the invention provided with a shaping zone comprising different types of cuts;

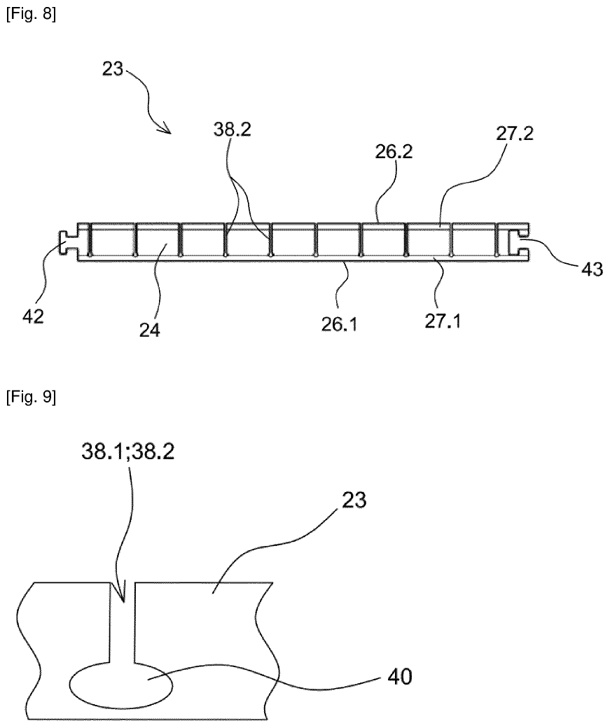

FIG. 8 is a top view of a finishing profile member according to the invention provided with butting shapes;

FIG. 9 is a side view of a cut provided with an oblong shape at one end to limit stress concentrations and prevent the material from splintering during shaping.

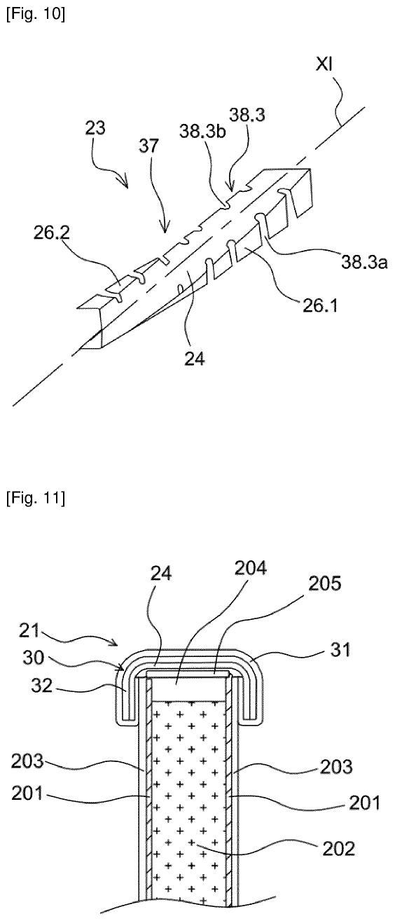

FIG. 10 is a perspective view of a shaped finishing profile member according to the invention provide with a third type of cut, the shaping process being carried out in the direction of the axis of the edge surface;

FIG. 11 is a sectional view of a composite panel with a finishing profile member according to the present invention mounted thereon;

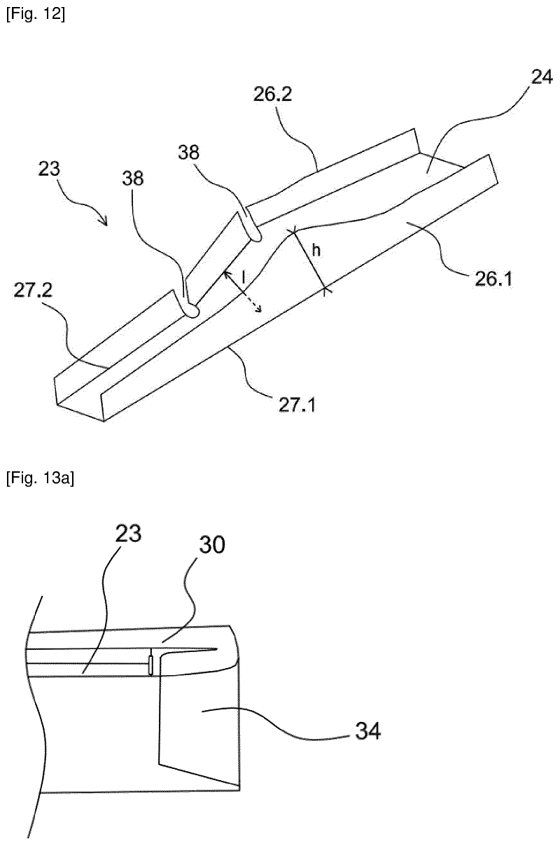

FIG. 12 is a perspective view of a finishing profile member according to the invention with variable height and/or width;

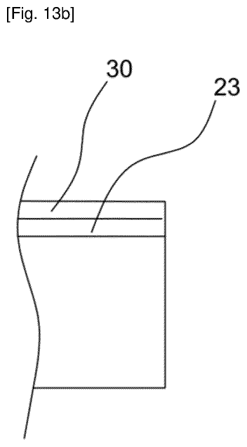

FIGS. 13a and 13b show sectional views along the section plane A-A in FIG. 2b of a finishing of the textile cover at the ends of the reinforcement respectively by a edging process or a straight cut.

It should be noted that the structural and/or functional elements common to the different embodiments have the same references. Thus, unless otherwise stated, such elements have identical structural, dimensional and material properties.

FIG. 1 shows a seat unit 10 comprising a seat 12 associated with a side console 13 extending along one side of the seat 12.

The seat 12 is advantageously provided with a kinematics allowing to move between a “sitting” position, in which the seat 12 is configured to define a position in which a passenger is seated, and a “reclined” position in which the seat 12 is configured to define for the passenger a sleeping surface, advantageously substantially horizontal. Intermediate comfort positions are also proposed, such as the “relaxed” position in which a backrest of the seat 12 is strongly inclined.

In addition, a shell 14, so-called a privacy shell, extends at least partly around the seat 12 so as to delimit a semi-enclosed space around the passenger. The privacy shell 14 is made for example from a composite material. Such a configuration makes it possible to guarantee the privacy of the passenger seated on the seat 12.

The console 13 may include an upper wall 16 forming a table on which the passenger can place objects as well as a storage space 17 comprising one or more elements from a literature pocket, a bottle holder, or a mini bar. The choice of storage is configurable according to the wishes of the airline.

In order to allow the passenger to lie down, the console 13 has an internal housing 19 in which is arranged an ottoman on which a rear passenger can place her/his feet when the seat 12 is in the “reclined” position.

Advantageously, the privacy shell 14 and/or the console 13 comprise at least one composite panel 20 having a structure of the so-called “sandwich” type, as shown in FIG. 11. Such a panel 20 is formed by composite walls 201 arranged on either side of a core 202 made of a honeycomb or foam material. The composite walls 201 are each formed by a stack of layers of carbon fibers or glass fibers coated with a thermoplastic or thermosetting resin. The external finish of the panel 20 is produced by a finishing layer 203 which can take the form of a layer of paint, a decorative film, or a textile. Optionally, the edge surface of the composite panel can be covered by a layer of bordering resin 204.

Alternatively, the panel 20 may be made of another material than a composite material, in particular a plastic, in particular thermoplastic, material. The panel 20 is shaped so as to at least partially surround the seat.

A finishing profile member 21 covers an edge surface of a panel 20 while following the curvature profile of the edge surface of the panel 20. The edge surface of a panel 20 extends according to the thickness of the panel 20. As can be seen in FIGS. 2a and 2b, the finishing member 21 comprises a profile reinforcement 23 extending, in the undeformed state, along a longitudinal extension direction D1. The longitudinal extension direction D1 is much greater than a width of the reinforcement 23, in particular at least 10 times greater than the width of the reinforcement 23. The reinforcement 23 is made of a rigid material allowing its plastic deformation to ensure its shaping according to the curvature profile of the edge surface of the panel 20. The reinforcement 23 is made for example of a material chosen from a metallic material such as aluminum, or a plastic material in particular of the polycarbonate type or other.

The reinforcement 23 comprises a wall 24, a first flank 26.1 and a second flank 26.2. A first fold 27.1 extends between a first longitudinal edge of the wall 24 and the first flank 26.1. A second fold 27.2 extends between a second longitudinal edge of the wall 24 and the second flank 26.2. The first flank 26.1 is thus connected to the wall 24 via the first fold 27.1. The second flank 26.2 is connected to the wall 24 via the second fold 27.2. The wall 24, the first flank 26.1 and the second flank 26.2 are walls extending longitudinally in the longitudinal extension direction D1. The first fold 27.1 and the second fold 27.2 preferably have identical radii of curvature.

The first flank 26.1 forms a non-zero angle, in particular an angle of the order of 90 degrees, relative to the wall 24. The second flank 26.2 forms a non-zero angle, in particular an angle of the order of 90 degrees, relative to the wall 24. By “of the order of” it is meant a variation of plus or minus 10% around the indicated value. The first flank 26.1 and the second flank 26.2 are preferably parallel to each other. The reinforcement 23 thus has a U-shaped cross-section. The reinforcement 23 is a single-piece part obtained by cutting shaping notches and then folding the flanks 26.1, 26.2 relative to the wall 24 along the folds 27.1, 27.2. Alternatively, the profile member can be obtained by U-shaped extrusion and then cutting the shaping notches. Thus, the profile member is carried out in a linear way and is foldable according to the curvature directions of the composite panels 20.

As can be seen in FIG. 11, the finishing profile member 21 covers the edge surface of one or more composite panels 20. For this purpose, the wall 24 bears on the edge surface of the composite panel 20 and the flanks 26.1, 26.2 cover the side faces of the composite panel 20 over a slight height. The finishing profile member 21 is glued to the edge surface of the panel 20 at the internal face of the wall 24 by means of a liquid, solid, and/or double-sided adhesive 205.

An extensible textile cover 30 at least partially covers the reinforcement 23. The textile cover 30 covers at least the external face of the reinforcement 23. By “external” face, it is meant the face facing the outside of the hollow of the U. In contrast, an “internal” face is a face facing the inside of the hollow of the U. In this case, the textile cover 30 covers the external face of the wall 24, the external face of the flanks 26.1, 26.2, the external face of the folds 27.1, 27.2, and the edge surface of the reinforcement 23. The reinforcement 23 is made in such a way that, when it is shaped on the edge surface of the panel 20, the textile cover 30 is deformed under tension to avoid unsightly folds thereof.

The textile cover 30 comprises at least one finishing layer 31 on the external face of the reinforcement. The finishing layer 31 is made of a flexible material of polymer or natural type (leather, cotton fabric, or other) having a good elasticity allowing its deformation, in particular its stretching, during the shaping of the finishing profile member 21. The finishing layer 31 is for example made of imitation leather or of a non-woven textile.

The textile cover 30 further comprises an underlayer 32 between the reinforcement 23 and the finishing layer 31 in order to mask the cuts described in more detail below. The underlayer 32 is also made of a flexible material of polymer or natural type (leather, cotton fabric, or other) having a good elasticity allowing its deformation, in particular its stretching, during the shaping of the finishing profile member 21. The underlayer 32 is for example made of a material chosen from imitation leather, foam, or a non-woven textile. The textile cover 30 has a sufficient elastic capacity for stretching according to the required folds. In the case where the finishing layer 31 would mask the deformation of the reinforcement 23 sufficiently well after its shaping on the edge surface of the panel 20, it would be possible to remove the underlayer 32.

The textile cover 30 is preferably glued to the reinforcement 23 of the finishing profile member 21, for example by means of a neoprene-type contact glue or a double-sided adhesive.

In order to improve the finish, the textile cover 30 may include a lateral bead 34 along which the textile cover 30 is folded over at least a portion of an internal face of the flanks 26.1, 26.2. The textile cover 30 thus covers at least a portion of an internal face of the flank 26.1, and at least a portion of an internal face of the flank 26.2. As illustrated in FIG. 13a, the textile cover 30 may also include a bead 34 at the end of the profile member, that is to say on the side of the longitudinal ends of the reinforcement 23, by folding the textile cover 30 over itself on the inner side of the reinforcement 23. This makes it possible to avoid folds in the textile cover 30 while keeping the textile cover 30 under tension due to the shaping process.

Alternatively, as illustrated in FIG. 13b, it is possible to make a straight cut of the textile cover 30 at the end of the profile member.

The reinforcement 23 comprises at least one shaping zone 37 in which a plurality of cuts 38.1, 38.2, 38.3 are made, such that said reinforcement 23 can be shaped along the shaping zone 37 in order to follow a curvature profile of the edge surface of the panel 20. The reinforcement 23 covers the edge surface of the panel 20. The shaping of the reinforcement 23 corresponds to a folding operation for the reinforcement 23 which can be carried out manually by an operator. Due to this operation, the reinforcement 23 is deformed along the shaping zone(s) 37 so as to follow the curvature profile of the edge surface of the panel 20. This operation can however be carried out automatically by a robot. The cuts 38.1, 38.2, 38.3 are formed by through grooves in the entire thickness of the reinforcement 23. The cuts 38.1, 38.2, 38.3 may be produced by machining or by laser cutting. The cuts 38.1, 38.2, 38.3 have different shapes depending on the shaping directions of the reinforcement 23.

The shaping zone 37 comprises at least one cut selected from a first type of cut 38.1 shown in FIGS. 4a and 4b, a second type of cut 38.2 shown in FIGS. 5a and 5b and a third type of cut 38.3 shown in FIGS. 6a, 6b, and 6c.

More specifically, as illustrated in FIGS. 4a and 4b, the first type of cut 38.1 allows a shaping of the reinforcement 23 in the plane of the flans 26.1, 26.2 according to a convex shaping, so that a center of curvature C1 of the reinforcement 23 is located on the side of an internal face of the wall 24. A radius of curvature R1 passing through the center C1 is normal to the surfaces of the flanks 26.1, 26.2. The center C1 is located on an axis of curvature X1. The first type of cut 38.1 makes it possible to cover a convex cut edge surface and in the plane of the composite panel 20.

The first type of cut 38.1 extends in the wall 24 transversely to the direction D1 and extends on one side in the first fold 27.1 and along a portion of a width of the first flank 26.1, and on the other side in the second fold 27.2 and along a portion of a width of the second flank 26.2. The first type of cut 38.1 thus has a U-shape.

The center of curvature C1 is located on the side of the free end of the flanks 26.1, 26.2 so as to open the cuts 38.1 and extend the textile cover 30 during shaping.

The cut 38.1 ends at its ends with a portion 40 of rounded shape. This makes it possible to limit stress concentrations and to limit the risk of tearing of the reinforcement 23 when the operator shapes the reinforcement 23 on the edge surface of the panel 20. Alternatively, as illustrated in FIG. 9, the cut 38.1 may end with a portion 40 of oblong shape.

As illustrated in FIGS. 5a and 5b, the second type of cut 38.2 allows shaping of the reinforcement 23 in the plane of the wall 24 such that a center of curvature C2 of the reinforcement 23 is located on the side of one of the flanks 26.1, 26.2. A radius of curvature R2 passing through the center C2 is normal to the surface of the wall 24. The center C2 is located on an axis of curvature X2. The second type of cut 38.2 makes it possible to cover a cut edge surface according to the direction of curvature of the composite panel 20.

The second type of cut 38.2 extends in one of the flanks 26.1, 26.2, the corresponding fold 27.1, 27.2 connecting said flank 26.1 or 26.2 to the wall 24, as well as in the wall 24 preferably up to the next fold. The second type of cut 38.2 thus has an L shape. The center of curvature C2 is located on the side of the uncut flank 26.1, 26.2 so as to open the cuts 38.2 and extend the textile cover 30 during shaping.

Depending on the desired shaping direction in the plane of the wall 24, the cut 38.2 is made in the first flank 26.1 or the second flank 26.2. Thus, as shown in FIGS. 5a and 5b, in the case where the center of curvature C2 of the reinforcement 23 is located on the side of the first flank 26.1, the cut 38.2 is made in the second flank 26.2, the second fold 27.2, and at least partly in the wall 24. In the case where the center of curvature of the reinforcement 23 is located on the side of the second flank 26.2, the cut 38.2 is made in the first flank 26.1, the first fold 27.1, and at least partly in the wall 24.

The cut 38.2 ends at least at one of its ends with a portion 40 of rounded shape. This makes it possible to limit stress concentrations and to limit the risk of tearing of the reinforcement 23 when the operator shapes the reinforcement 23 on the edge surface of the panel 20. Alternatively, as illustrated in FIG. 9, the cut 38.2 may end with a portion 40 of oblong shape.

As illustrated in FIGS. 6a, 6b and 6c, the third type of cut 38.3 allows the reinforcement 23 to be shaped in the plane of the flanks 26.1, 26.2 according to a concave shape, such that a center of curvature C3 of the reinforcement 23 is located on the side of an external face of the wall 24. A radius of curvature R3 passing through the center C3 is normal to the surfaces of the flanks 26.1, 26.2. The center C3 is located on an axis of curvature X3. The third type of cut 38.3 makes it possible to cover a concave cut edge surface and in the plane of the composite panel 20.

As shown in FIG. 10, this type of cut also allows a twisting folding process around the longitudinal axis XI of the reinforcement 23. The axis XI extends parallel to the longitudinal extension direction D1 of the reinforcement 23 in the undeformed state, i.e. when the reinforcement 23 has not yet been shaped.

As can be seen in FIG. 6c, the third type of cut 38.3 comprises a first cut portion 38.3a extending along the entire width of the first flank 26.1 and slightly beyond the first fold 27.1. The first cut portion 38.3a does not reach the second fold 27.2. The third type of cut 38.3 comprises a second cut portion 38.3b extending along the entire width of the second flank 26.2 and slightly beyond the second fold 27.2. The second cut portion 38.3b does not reach the first fold 27.1. The first cut portion 38.3a and the second cut portion 38.3b are located in the same plane P perpendicular to the longitudinal extension direction D1.

The center of curvature C3 is located on the side of the external face of the wall 24 so as to open the cuts 38.3 and extend the textile cover 30. The center of curvature C3 is preferably arranged in the middle of the wall 24.

As illustrated in FIGS. 7a, 7b, and 7c, the finishing profile member 21 may comprise several shaping zones 37 having cuts 38.1, 38.2, 38.3 of different shapes so as to be able to follow a panel edge surface profile having successive directions of curvature in different successive directions.

One thus distinguishes a first shaping zone 37 provided with the second type of cut 38.2, as well as two zones 37′ and 37″ comprising an alternation of two different types of cuts to adapt to simultaneous variations in curvature, in particular combined shaping processes according to two different directions of curvature.

Thus, the shaping zone 37′ comprises an alternation of the first type of cut 38.1 and the second type of cut 38.2 making it possible to shape the finishing profile member according to a center of curvature C2 located on the side of the second flank 26.2. There is an alternation of a single cut of the first type 38.1 then a single cut of the second type 38.2 then a single cut of the first type 38.1 and so on. As a variant, there may be an alternation of a series of cuts of the first type 38.1 then a series of cuts of the second type 38.2.

The shaping zone 37″ includes an alternation of a first type of cut 38.1 and a second type of cut 38.2 allowing the shaping of the finishing profile member according to a center of curvature C2 located on the side of the first flank 26.1.

Alternatively, the second type of cut 38.2 and the third type of cut 38.3 can be alternately combined.

According to an exemplary embodiment shown in FIG. 3, the reinforcement 23 of the finishing profile member 21 has a thickness e between 0.5 mm and 1.5 mm, a width 1 linked to the thickness of the edge surface of the panel between 10 mm and 20 mm, and a height h sufficient to hide the defects of the edges of the panel between 5 mm and 10 mm.

Dimension 1 is sized so that dimension L1 between the internal faces of the flans of the finishing profile member 21 provided with the textile cover 30 (see FIG. 2b) is adjusted to the thickness dimension of the panel 20, taking into account the thickness of the beads and the decorations of the panel 20.

Alternatively, as shown in FIG. 12, dimension 1 may vary in length so as to adapt to composite panels 20 of varying thickness. It is possible to provide for successions of shaping operations 27.1, 27.2 by making cuts 38 at the flanks 26.1, 26.2 at each change in edge surface profile gradient.

Alternatively, the dimension h can vary in height to hide more or less of the panel edges 20.

The dimensioning of the cuts 38.1, 38.2, 38.3 depends on the flexibility and plasticity of the materials. A cut 38.1, 38.2, 38.3 may for example have a width Id of the order of 1 mm in the undeformed state (see FIG. 4b). A width of a cut in the deformed state is preferably less than twice the width of a cut in the undeformed state not to exceed the stretching limits of the material.

In the embodiment in FIG. 8, the finishing profile member 21 comprises a male butting shape 42 on the side of a first end and a female butting shape 43 on the side of a second end. The female butting shape 43 has a shape complementary to the male butting shape 42. The butting shapes 42, 43 are preferably made in the wall 24 of the reinforcement 23. As a variant or in addition, the butting shapes 42, 43 may be carried out in the flanks 26.1, 26.2 of the reinforcement 23.

The finishing profiles 21 can thus be butted together. For this purpose, the male butting shape 42 cooperates with a female butting shape 43 of a first adjacent finishing profile member 21 and the female butting shape 43 cooperates with a male butting shape 42 of a second adjacent finishing profile member 21. This provides a modular structure according to which the number of finishing profile members 21 can be adapted to the length of the edge surface of the panel.

A textile cover 30 may cover all of the finishing profile members 21 thus assembled. The connections between the finishing profile members 21 may be reinforced by the use of an adhesive or by producing one or more weld points at the interconnection between a male butting shape 42 and a female butting shape 43.

The male butting shape 42 and the female butting shape 43 may have complementary T shapes as shown. Any other shape suitable for the application, including a rounded hook shape, an L shape, a dovetail shape, or any other shape suitable for the application is conceivable.

The finishing profile member(s) 21 may be glued to the edge surface of a panel 20 by means of a double-sided adhesive or liquid or solid adhesive.

On the straight portions, the finishing profile member 21 can of course be free of cuts 38.1, 38.2, 38.3.

Of course, the different characteristics, variants and/or embodiments of the present invention can be associated with each other in various combinations insofar as they are not incompatible with or exclusive of one another. Furthermore, the invention is not limited to the embodiments described above and provided solely by way of example. It encompasses various modifications, alternative forms and other variants which a person skilled in the art may envisage in the context of the present invention and in particular any combination of the various operating modes described above may be taken separately or in combination.

1. A finishing profile member for covering an edge surface of a panel, said panel being formed by composite walls arranged on either side of a core made of a honeycomb or foam material, an external finish of the panel being produced by a finishing layer, wherein said finishing profile member comprises:
a reinforcement comprising a wall, a first flank and a second flank, a first fold extending between a first longitudinal edge of the wall and the first flank, a second fold extending between a second longitudinal edge of the wall and the second flank; and
an extensible textile cover at least partially covering said reinforcement,
said reinforcement comprising at least one shaping zone in which a plurality of cuts are made, such that said reinforcement can be shaped along the shaping zone to follow a curvature profile of the edge surface of the panel.

2. The finishing profile member according to claim 1, wherein the shaping zone comprises at least one cut of the reinforcement chosen from:
a first type of cut allowing shaping of the reinforcement in the plane of the flanks according to a convex shaping, so that a center of curvature of the reinforcement is located on the side of an internal face of the wall;
a second type of cut allowing shaping of the reinforcement in the plane of the wall, so that a center of curvature of the reinforcement is located on the side of one of the flanks; and
a third type of cut allowing shaping of the reinforcement in the plane of the flanks according to a concave shaping, so that a center of curvature of the reinforcement is located on the side of an external face of the wall, the third type of cut also allowing a twisting shaping process.

3. The finishing profile member according to claim 1, wherein at least one cut extends transversely in the wall, and extends on one side in the first fold and along a portion of a width of the first flank, and on the other side in the second fold and along a portion of a width of the second flank.

4. The finishing profile member according to claim 1, wherein at least one cut extends in one of the flanks, the corresponding fold connecting said flank to the wall, as well as in the wall up to the next fold.

5. The finishing profile member according to claim 3, wherein a cut ends at least at one of its ends with a portion of rounded or oblong shape.

6. The finishing profile member according to claim 1, wherein at least one cut comprises:
a first cut portion extending along the entire width of the first flank and slightly beyond the first fold; and
a second cut portion extending along the entire width of the second flank and slightly beyond the second fold,
the first cut portion and the second cut portion being located in the same plane perpendicular to a longitudinal extension direction of the finishing profile member.

7. The finishing profile member according to claim 1, further comprising several shaping zones having cuts of different shapes so as to be able to follow a panel edge surface profile having successive directions of curvature in different successive directions.

8. The finishing profile member according to claim 1, wherein the shaping zone comprises an alternation of two different types of cuts to adapt to simultaneous variations in curvature.

9. The finishing profile member according to claim 1, wherein the textile cover comprises at least one finishing layer.

10. The finishing profile member according to claim 1, further comprising a male butting shape on the side of a first end and a female butting shape on the side of a second end, said female butting shape having a shape complementary to the male butting shape.
